(19) United States
(12) Patent Application Publication
(10) Pub. No.: US 2022/0000050 A1
(43) Pub. Date: Jan. 6, 2022

(54) CONTAINER UNIT AND CONTAINER ASSEMBLY FOR HYDROPONICS

(71) Applicant: YEH KAI HSU, TAICHUNG CITY (TW)

(72) Inventor: YEH KAI HSU, TAICHUNG CITY (TW)

(21) Appl. No.: 17/341,739

(22) Filed: Jun. 8, 2021

(30) Foreign Application Priority Data
Jul. 6, 2020 (TW) 109208576

(51) Int. Cl. A01G 31/06; A01G 27/00

(52) U.S. Cl. CPC A01G 31/06; A01G 27/006; A01G 27/003

(57) ABSTRACT

A container unit for hydroponics includes a container having an overflow unit and an outflow unit located therein. The overflow unit includes an overflow tube, and the outflow unit includes a siphon pipe which is height adjustable. A cover is mounted to the container and includes an opening, a first hole and a second hole. A pot is engaged with the opening of the cover. Two hooks are connected to the back of the container so as to be hooked to a shelve to form multiple rows of the containers between which the overflow tubes and the outflow tubes are connected via the first and second holes of the containers. The overflow tube and siphon pipe control the water level in the container to prevent plant root from being rotted.

### BACKGROUND OF THE INVENTION

### 1. Fields of the Invention

The present invention relates to hydroponics, and more particularly, to a contain unit and a container assembly for hydroponics.

### 2. Descriptions of Related Art

The cultivation of agricultural crops has been affected by the poor natural environment and unstable climate, causing many crops to suffer from natural disasters, insect pests, environmental pollution and other uncontrollable factors. In order to improve the above-mentioned shortcomings, plant cultivation equipment with LED artificial light sources in a controllable indoor environment has gradually developed.

Hydroponics is an alternative way to grow plants, for example, the planting substrate sponge is placed in the hole of the floating device (usually styrofoam), and the plant is planted in the sponge. In order for plants to absorb enough nutrients, the irrigation motor must operate for a long time every day to transport the water and nutrient solution to the required breeding pot, which causes the power consumption of the motors.

The present invention intends to provide a container unit and a container assembly for hydroponics to eliminate shortcomings mentioned above.

### SUMMARY OF THE INVENTION

The present invention relates to a container unit for hydroponics, and comprises a container having an overflow unit and an outflow unit located therein. The overflow unit includes an overflow tube, and the outflow unit includes a siphon pipe which is height adjustable. A cover is mounted to the container and has an opening, a first hole and a second hole. A pot is engaged with the opening of the cover. At least one hook is connected to the back of the container. The overflow tube and siphon pipe control water level in the container to prevent plant root from being rotted.

Preferably, the container includes a reception part on at least one side thereof. A light part is inserted into the reception part and includes a clip.

Preferably, the top face of the container is inclined downward 37 degrees relative to a horizontal plane. A concaved and curved face is formed to a front face of the container.

Preferably, the siphon pipe is a U-shaped pipe and includes a U-section which has an oval cross section. The siphon pipe includes an inlet formed in the first end thereof.

Preferably, the outflow unit includes an outlet formed through the underside of the container. The second end of the siphon pipe is inserted into the outlet.

Preferably, multiple seal rings are located between the outlet and the second end of the siphon pipe.

The present invention provide a container assembly for hydroponics, and the container assembly comprises multiple containers units and each container unit includes a container, an overflow tube, a cover and a pot. Each container has an overflow unit and an outflow unit located therein. The overflow unit includes the overflow tube. The outflow unit includes a siphon pipe which is height adjustable. The outflow unit includes an outlet formed through the underside of the container. The cover is mounted to the container and has an opening, a first hole and a second hole. The pot is engaged with the opening of the cover. At least one hook is connected to the back of the container. A shelve includes a frame which is connected to a water tank. The frame includes multiple transverse bars. A feeding tube has an end thereof connected with a motor in the water tank.

The multiple containers are hooked to the transverse bars by the at least one hook of each container so as to form at least two rows of containers along the transverse bars. The feeding tube includes multiple dripping tubes which are respectively inserted into the second holes of the containers of the first row of the containers.

The overflow tubes of the containers of the first row of the containers are inserted into the first holes of the containers of the second row of the containers. An outflow tube is connected to the outlet of each of the containers of the first row of the containers. The outflow tubes of the first row of the containers are inserted into the second holes of the containers of the second row of the containers. The outlet of each container of the second row of the containers face the water tank.

Preferably, at least two light parts are connected to the transverse bar. Each light part includes a light tube.

The advantages of the present invention are that the shelves provide multiple rows of containers so as to increase production rate. The inclined top face of each container allow the plant to face toward the light.

The height of the siphon pipe of each container can be adjusted according to different plant so as to prevent the plant roots from being rotted.

The siphon effect of each container is able to reduce the consumption of electricity and save operation time of the motors.

The light parts are easily installed to the shelves and provide sufficient light to the plants such that the plants grow normally regardless of the seasons.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the container unit of the present invention;

FIG. 2 is an exploded view of the container unit of the present invention;

FIG. 3 illustrates the operation of the siphon pipe of the container unit;

FIG. 4 illustrates the height adjustment of the siphon pipe of the container unit;

FIG. 5 shows the container assembly for hydroponics of the present invention, and

FIG. 5a shows the water flow of the container assembly for hydroponics of the present invention.

### DETAILED DESCRIPTION OF THE PREFERRED EMBODIMENT

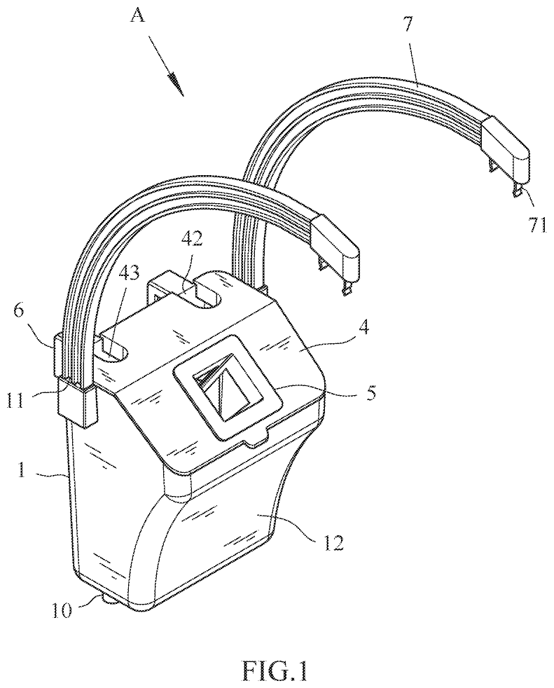

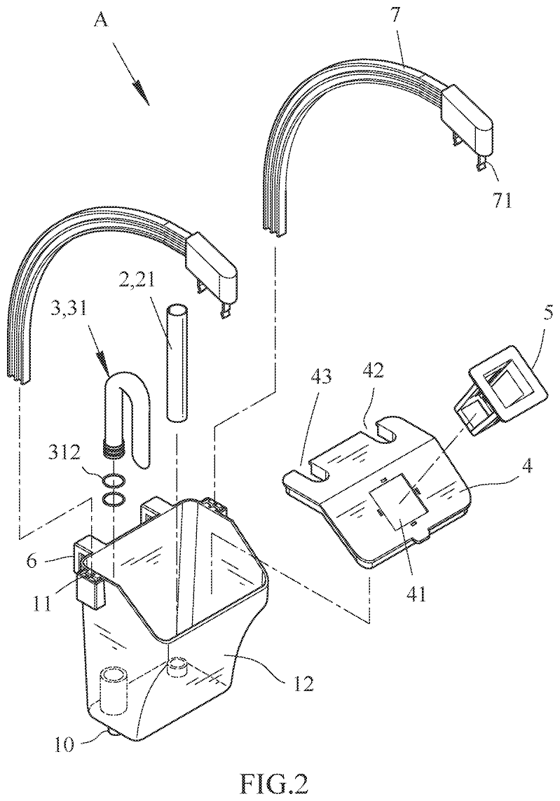

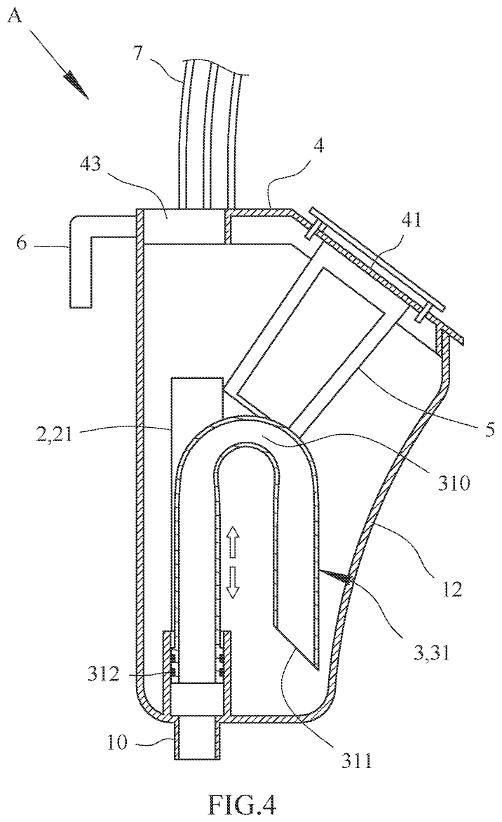

Referring to FIGS. 1 to 4, the container unit “A” for hydroponics of the present invention comprises a container 1 having an overflow unit 2 and an outflow unit 3 located therein. The overflow unit 2 includes an overflow tube 21, and the outflow unit 3 includes a siphon pipe 31 which is height adjustable. The outflow unit 3 includes an outlet 10 formed through the underside of the container 1. The siphon pipe 31 is a U-shaped pipe and includes a U-section 310 which has an oval cross section. The siphon pipe 31 includes an inlet 311 formed in the first end thereof. The second end of the siphon pipe 31 is inserted into the outlet 10. Multiple seal rings 312 are located between the outlet 10 and the second end of the siphon pipe 31.

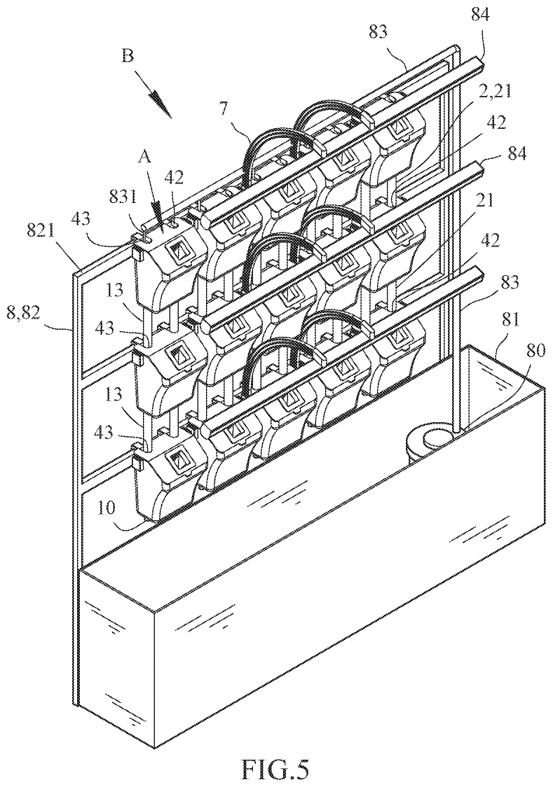

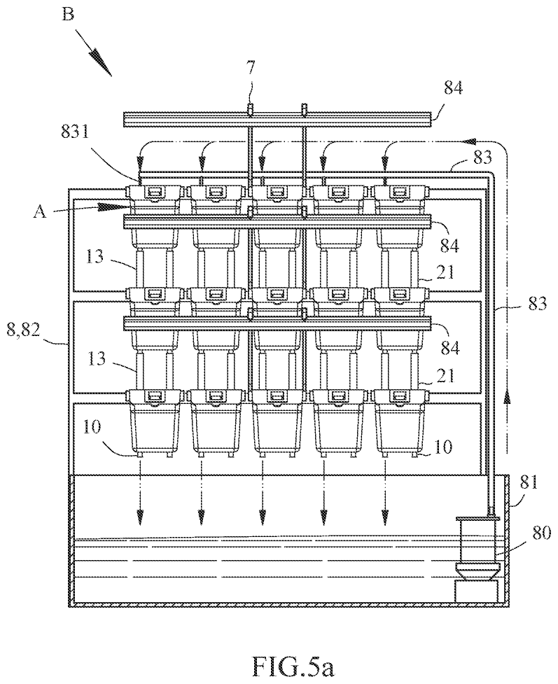

A cover 4 is mounted to the container 1 and has an opening 41, a first hole 42 and a second hole 43. A pot 5 is engaged with the opening 41 of the cover 4. At least one hook 6 is connected to the back of the container 1. The container 1 includes a reception part 11 on at least one side thereof. A light part 7 is inserted into the reception part 11 and includes a clip 71 so as to secure a light tube 84 as shown in FIG. 5. The overflow tube 21 and siphon pipe 31 control water level in the container 1 to prevent plant root from being rotted.

The top face of each of the containers 1 is inclined downward 37 degrees relative to a horizontal plane so that the plant in the pot is tilt and grows toward light. A concaved and curved face 12 is formed to a front face of the container 1.

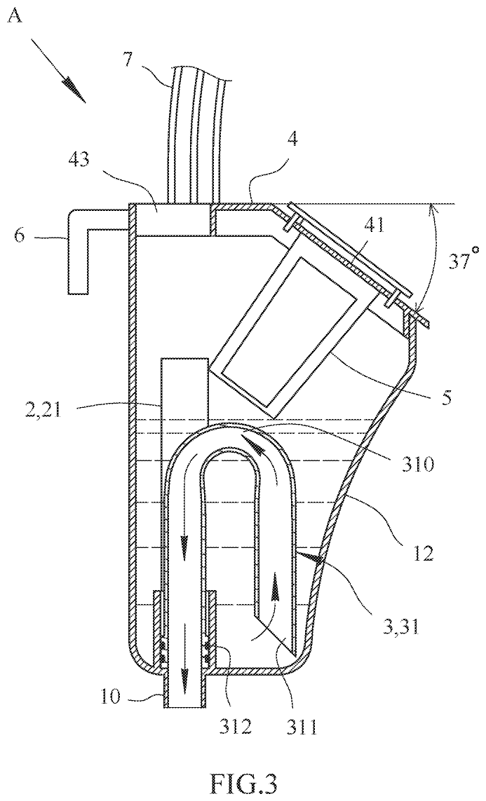

As shown in FIGS. 3, 5 and 5a, a container assembly “B” for hydroponics is disclosed and comprises a shelve 8 including a frame 82 which is connected to a water tank 81. The frame 82 includes multiple transverse bars 821. A feeding tube 83 has one end thereof connected with a motor 80 in the water tank 81 so as to pump nutrient solution or liquid from the water tank 81 to the containers “A”.

The multiple containers 1 are hooked to the transverse bars 821 by the at least one hook 6 of each container 1 so as to form at least two rows of containers 1 along the transverse bars 821. The feeding tube 83 includes multiple dripping tubes 831 which are respectively inserted into the second holes 43 of the containers 1 of the first row or the top row of the containers 1. The overflow tubes 21 of the containers 1 of the first row of the containers 1 are inserted into the first holes 42 of the containers 1 of the second row of the containers 1. The second row of the containers “A” are located below the first row of the containers “A”. The outflow tube 13 is connected to the outlet 10 of each of the containers 1 of the first row of the containers 1, and the outflow tubes 13 of the first row of the containers 1 are inserted into the second holes 43 of the containers 1 of the second row of the containers 1. The outlet 10 of each container 1 of the second row of the containers 1 face the water tank 81. The shelve 8 may have multiple rows of the containers “A” which are interconnected by the overflow tubes 21 and the outflow tubes 13.

The nutrient liquid are provided to the containers “A” via the dripping pipes 831 connected to the feeding tube 83. When the water level of the nutrient liquid in the containers “A” reaches the top of the siphon tube 13, the siphon tube 13 is operated so that the nutrient liquid in the containers “A” flows downward to the containers “A” of the lower row of the containers “A”. When the water level of the upper row of the containers “A” is lowered and below the inlet 311 of the siphon tube 31, the siphon tube 31 sucks air to stop the nutrient liquid from flowing out. The nutrient liquid eventually drops into the water tank 81 from the lowest row of the containers “A”. The water level of the nutrient liquid in each container “A” is lowered regularly to let the plant roots to such the nutrients and air. The nutrient liquid circulates to provide nutrient to the plant, while the plant roots are protected from being rotted.

The siphon tube 31 can be adjusted according to different needs of different plants, and the seal rings 312 ensure the sealing feature so that the water level can be precisely controlled.

It is noted that the U-section 310 of the siphon tube 31 has an oval cross section. When the nutrient liquid reaches the U-section 310, the water level in the siphon tube 31 increases quickly and the nutrient liquid together with the air in the siphon tube 31 flow toward the second end of the siphon tube 31. Therefore, the siphon effect is effective and only limited nutrient liquid is required.

When a foreign object is sucked in the siphon tube 31 and the siphon tube 31 fails to normally operate, the water level is increased in the container “A” and will flows to the lower row of the containers “A” via the overflow tube 21.

The container assembly “B” include multiple rows of the containers “A” and arranged from upper position to lower position, so that the nutrient liquid can flows downward from the first row to the last (the lowest) row of the containers “A”. This saves the nutrient liquid required and also saves the electricity required for the motor 80.

As shown in FIGS. 5 and 5a, the light parts 7 are easily positioned to the containers “A” by the reception parts 11, and the light tubes 84 are secured to the light parts 7 which provide light to the plants in the pots 5 when desired in any season.

While we have shown and described the embodiment in accordance with the present invention, it should be clear to those skilled in the art that further embodiments may be made without departing from the scope of the present invention.

What is claimed is:

1. A container unit for hydroponics, comprising:
a container having an overflow unit and an outflow unit located therein, the overflow unit including an overflow tube, the outflow unit including a siphon pipe which is height adjustable;
a cover mounted to the container and having an opening, a first hole and a second hole;
a pot engaged with the opening of the cover, and
at least one hook connected to a back of the container, the overflow tube and siphon pipe configured to control water level in the container to prevent plant root from being rotted.

2. The container unit as claimed in claim 1, wherein the container includes a reception part on at least one side thereof, a light part is inserted into the reception part and includes a clip.

3. The container unit as claimed in claim 1, wherein a top face of the container is inclined downward 37 degrees relative to a horizontal plane, a concaved and curved face is formed to a front face of the container.

4. The container unit as claimed in claim 1, wherein the siphon pipe is a U-shaped pipe and includes a U-section which has an oval cross section, the siphon pipe includes an inlet formed in a first end thereof.

5. The container unit as claimed in claim 1, wherein the outflow unit includes an outlet formed through an underside of the container, a second end of the siphon pipe is inserted into the outlet.

6. The container unit as claimed in claim 5, wherein multiple seal rings are located between the outlet and the second end of the siphon pipe.

7. A container assembly for hydroponics, comprising:
multiple containers each having a container, an overflow tube, a cover and a pot;
each container having an overflow unit and an outflow unit located therein, the overflow unit including the overflow tube, the outflow unit including a siphon pipe which is height adjustable, the outflow unit including an outlet formed through an underside of the container;
the cover mounted to the container and having an opening, a first hole and a second hole;
the pot engaged with the opening of the cover;
at least one hook connected to a back of the container;
a shelve including a frame which is connected to a water tank, the frame including multiple transverse bars, a feeding tube having an end thereof connected with a motor in the water tank, and
the multiple containers are hooked to the transverse bars by the at least one hook of each container so as to form at least two rows of containers along the transverse bars, the feeding tube including multiple dripping tubes which are respectively inserted into the second holes of the containers of a first row of the containers, wherein the overflow tubes of the containers of the first row of the containers are inserted into the first holes of the containers of a second row of the containers, an outflow tube is connected to the outlet of each of the containers of the first row of the containers, the outflow tubes of the first row of the containers are inserted into the second holes of the containers of the second row of the containers, the outlet of each container of the second row of the containers face the water tank.

8. The container assembly as claimed in claim 7, wherein at least two light parts are connected to the transverse bar, each light part includes a light tube.
